(19) United States
(12) Patent Application Publication
(10) Pub. No.: US 2019/0385488 A1
(43) Pub. Date: Dec. 19, 2019

(54) DEMONSTRATION MACHINE ENABLING THE COMPARISON OF A MASK FILTER

(71) Applicant: DONGGUAN UNIVERSITY OF TECHNOLOGY, Dongguan (CN)

(72) Inventors: JUN DENG, Dongguan (CN); Shouyan Zhong, Dongguan (CN)

(21) Appl. No.: 16/289,710

(22) Filed: Mar. 1, 2019

(30) Foreign Application Priority Data
Jun. 15, 2018 (CN) CN2018106236800
Dec. 26, 2018 (JP) JP2018-243747

(51) Int. Cl. G09B 25/00; G09B 5/00; B01D 46/00

(52) U.S. Cl. CPC G09B 25/00; A41D 13/11; B01D 46/0005; G09B 5/00

(57) ABSTRACT

The present invention relates to a demonstration device enabling the contrast of mask filters comprising a cabinet wherein a dust cavity and a demonstration cavity with right opening are formed with a partition plate. On the partition plate is set a communication port to communicate the dust cavity with the demonstration cavity. On the upper part of the demonstration cavity, are set a dust collecting movable motor and a dust collecting movable screw which cooperate with each other, and on the said dust collecting movable screw, a dust collecting movable block is fixed by plug push cooperation. To the lower end of the dust collecting movable block, a dust collecting rotary motor is installed and under the dust collecting rotary motor, a dust collecting frame is installed. In the middle of the dust collecting frame, a dust collecting partition plate is installed. On the bottom of the dust collecting frame and on both sides of the dust collecting partition plates, dust collecting contrast blocks are installed. On either right and left sides of the dust collecting frame, a mask filter and contrast device which use masks to function which are both connected to the inner cavities are respectively installed. Both the mask filters and contrast devices are connected to the communication port. The present invention may directly present the dust-proof effects of the mask filters compared with common facial masks and achieve good teaching experience.

### FIELD OF THE INVENTION

The present invention relates to a teaching demonstration device, and more especially to a demonstration device enabling the contrast of mask filters.

### BACKGROUND OF THE INVENTION

As factories are subject to various uncertainties, many kinds of safety appliances may be used, mainly special purpose leather shoes, safety helmets, gloves, dust-proof masks and so on.

Of all kinds of safety appliances, dust mask is the most likely to be neglected however the most important one. Furthermore, mask filter plays the most important role of the dust mask, and as is shown in FIG. 9, mask filters may include a filter column 401 and a filter sleeve 402. In order to enable students to deeply understand the role of dust masks, some colleges offer demonstration courses. However, the existing demonstration tools are relatively simple and not conducive to effective comparison and verification, and students need to wear dust masks to experience the simulated environment which takes long teaching time.

### SUMMARY OF THE INVENTION

The present invention discloses a demonstration device enabling the contrast of mask filters including a dust collecting partition plate which is installed on a rotatable dust collecting frame. On both sides of the dust collecting partition plate, a mask filter and a mask used as the contrast device are installed. By measuring the amount of dust on two dust collecting contrast blocks which are installed on the bottom of dust collecting frame, the dust-proof function of mask filter could be directly represented, ensuring good teaching quality.

To achieve the above purpose, this invention adopts following technology: a demonstration device enabling the contrast of mask filters comprising a cabinet wherein a dust cavity and a demonstration cavity with right opening are formed with a partition plate. On the partition plate is set a communication port to communicate the dust cavity with the demonstration cavity. On the upper part of the demonstration cavity, are set a dust collecting movable motor and a dust collecting movable screw which cooperate with each other, and on the said dust collecting movable screw, a dust collecting movable block is fixed by plug push cooperation. To the lower end of the dust collecting movable block, a dust collecting rotary motor is installed and under the dust collecting rotary motor, a dust collecting frame is installed. In the middle of the dust collecting frame, a dust collecting partition plate is installed. On the bottom of the dust collecting frame and on both sides of the dust collecting partition plates, dust collecting contrast blocks are installed. On either right and left sides of the dust collecting frame, a mask filter and contrast device which use masks to function which are both connected to the inner cavities are respectively installed. Both the mask filters and contrast devices are connected to the communication port.

Furthermore, the left end of the communication port is secured to a mask sealing conic sleeve which is big in its left end and small in its right one. The right opening's size of the sealing taper sleeve of mask is bigger than the outer diameter of filter column but smaller than the outer diameter of the left end of the filter sleeve.

Furthermore, a dust blocking ventilation piece is installed on both above and below the communication port and blowing air compressor which blows air towards central part of the dust cavity are installed on the upper corner and lower corner of the dust cavity. And on side wall of the dust cavity between two dust blocking ventilation pieces, a material inlet cover which may comprise a material inlet cover body is installed. The material inlet cover body fits the side walls of the dust cavity with plug push cooperation, and a material inlet handle is installed thereon. On both upper and lower sides of the material inlet cover body, a cover position limit hole which runs vertically is fixed. The cover position limit holes are connected to cover position limit blocks respectively via the cover position limit springs. On the side walls of the dust cavity, the cover position limit slots which cooperate the cover position limit blocks are installed.

Furthermore, on the left board of the dust collecting frame, a filter communication hole which fits with the filter column is installed. On the lower and upper end of the filter communication hole, a filter clamping device which may comprise a filter holding and mounting block which is secured to outer side board of the dust collecting frame is installed. The side of the filter holding and mounting blocks facing to the filter communication hole are connected to a filter clamping block which cooperates with the filter sleeve by the clamping spring of filter. The outer side of the filter clamping blocks is secured with a filter holding control rod with handle and the filter holding control rod is connected to the filter holding and mounting block by plug fitting.

Furthermore, the outer shape of the filter communication hole is a tapered hole which fits the filter sleeve, while the inner one of filter communication hole is a cylindrical hole which fits the right end of filter column. On outside of the filter sleeve, a clamping engaging hole is installed. In the same time, in the filter clamping block, a filter clamping pole which fits clamping engaging hole is installed.

Furthermore, the contrast device may comprise a contrast sleeve inserted to the right board of the dusting collection frame and axis of which is consistent with that of filter column. Opening size of the contrast sleeve is the same as that of the left side of the filter column. On the right side of the contrast sleeve, a mask is installed by a mask locking sleeve and in the middle of the mask locking sleeve, a ventilation port is installed, whose opening is coincident with the that of the contrast sleeve.

Furthermore, the dust collecting frame is frame with open lower end, where a lower dust collecting case is connected therein. On the lower dusting collecting case, lower case plug rods which fits the dust collecting frames and the dust collecting partition plate are installed by plug and fit connection. The dust collecting contrast block are installed in the lower dusting collecting case. And on the left and right to the outside of the dust collecting frame, lower case reclaiming openings are set. To the right side of the lower end of the demonstration cavity, a lower dusting collecting case holding device which fits the lower case reclaiming opening is installed.

Furthermore, the lower dusting collecting case holding device may comprise a lower case claiming and lifting gas cylinder which is installed on the bottom board of the cabinet. On the lower case claiming and lifting gas cylinder, a lower case clamping gas cylinder which runs horizontally is installed. And the left and right ends of the lower case clamping gas cylinder is connected to a lower case clamping block which fits the lower case reclaiming opening. And when the lower case clamping block fits the lower case reclaiming opening by plug push cooperation, the bottom of the lower dusting collecting case contacts the upper side of the lower case clamping gas cylinder.

Furthermore, under the lower case clamping gas cylinder on the cabinet are fixed clamping buffers. In the clamping buffer, there is installed a clamping buffer hole and a clamping buffer spring is installed in the hole. The clamping buffer spring is connected to clamping buffer column, and the upper end of the clamping buffer column is connected to the lower case clamping gas cylinder.

Furthermore, wherein on the upper end of the clamping buffer spring, a spring connection block is installed. The spring connection block is in inverted T shape, whose vertical portion is a threaded rod. The lower end of the clamping buffer column fits the spring connection block by thread connection. On the lower part of the lower case clamping gas cylinder, a buffer column socket which matches the upper end of the clamping buffer column with plug push cooperation is installed. In the middle of the buffer column socket is set a buffer column positioning ring slot, the counterpart of which in the clamping buffer column is set a movable positioning arc block slot. In the movable positioning arc block slot, is set a buffer column positioning arc block which cooperates with the buffer column positioning ring slot, and is connected to a movable positioning arc block fixing pole.

The beneficial effects of the present invention are shown as follows:

A dust collecting partition plate is installed in the center part of rotational dust collecting frame and on both sides of the dust collecting partition plate, a mask filter and a mask used as contrast device are installed. By measuring the amount of dust on two dust collecting contrast blocks which are installed on the bottom of dust collecting frame, the dust-proof function of mask filters compared with common facial masks could be directly presented, ensuring good teaching quality.

With the design of sealing taper sleeve, mask filters could be sealed to make sure the dust could only go out through mask filter and contrast device.

The design of material inlet cover and the blown air inner the dust cavity may facilitate the material loading process, which may simulate the fluid dust space of factory environment.

With the design of the filter clamping device, the mask filters are easy to clamp and remove, which conduces to the replacement of dust mask.

With the design of filter communication hole, clamping insert rod of filter fits clamping engaging hole with plug push cooperation, which could effectively clamp and locate the mask filter, ensuring that demonstrations are conducted properly.

With simple structure of the contrast device, it is easy to pick and place the mask.

With the design of lower dusting collecting case, it is convenient to pick and replace the dust collecting contrast block. Furthermore, it can improve the operation efficiency of multiple test validation.

With simple structure and the easy operation of lower dusting collecting case holding device, which conduces to pick and replace the dust collecting frame.

With the design of clamping buffer and clamping buffer spring, it could play a buffer role in taking and discharging the lower dusting collecting case and ensure the stability of taking and discharging, which could guarantee good dust collecting contrast of the dust collecting contrast block.

With the design of movable annular groove of clamping arc block, movable latch lever of clamping arc block and buffer column positioning ring slot, clamping buffer column could rotate and structural design of spring connection block also facilitate removal and maintenance of the whole device.

### BRIEF DESCRIPTION OF THE DRAWINGS

FIG. 1 shows a stereoscopic view of A demonstration device enabling the contrast of mask filters;

FIG. 2 shows the structural drawing of the test part;

FIG. 3 shows the structural drawing of the filter clamping device;

FIG. 4 shows the structural drawing of the lower dusting collecting case holding device;

FIG. 5 is an enlarged view of A in FIG. 4;

FIG. 6 is a sectional view taken along line B-B in FIG. 5;

FIG. 7 shows the structural drawing material inlet cover;

FIG. 8 is enlarged view of C in FIG. 1; and

FIG. 9 shows the structural drawing of the mask filter.

### DETAILED DESCRIPTION OF THE ILLUSTRATED EMBODIMENT

All various components in the FIGURES are as follows:

1. cabinet,
2. partition plate,
3. communication port,
4. mask filter,
8. mask sealing conic sleeve,
10. dust blocking ventilation piece,
11. blowing air compressor,
12. material inlet cover,
13. contrast device,
14. clamping device for filters,
15. dust collecting movable motor,
16. dust collecting movable screw
17. dust collecting movable block,
19. lower dusting collecting case holding device,
21. dust collecting rotary motor,
22. dust collecting frame,
23, dust collecting contrast block.
24, dust collecting partition plate,
25. respiratory pump,
26. contrast sleeve,
27. mask,
28. mask locking sleeve,
29. lower dusting collecting case,
30. lower case plug rods,
31. lower case reclaiming openings,
32. lower case clamping block,
33. lower case clamping gas cylinder,
34. lower case claiming and lifting gas cylinder,
35. clamping buffers,
36. clamping buffer spring,
37. clamping buffer column,
38. spring connection block,
39. buffer column socket,
40. buffer column positioning arc block,
41. movable annular groove of clamping arc block,
42. movable positioning arc block fixing pole,
43. buffer column positioning ring slot,
45. material inlet cover body,
46. material inlet handle,
47. cover position limit springs,
48. cover position limit blocks.
51. filter communication hole,
52. filter holding and mounting block,
53. clamping spring of filter,
54. filter clamping block,
55. filter clamping pole,
56. filter holding control rod,
401. filter column,
402. filter sleeve,
403. clamping engaging hole.

In order to enable those skilled in the art to better understand the technical solution of the present invention, the present invention will be described in detail below with reference to the accompanying drawings and it should not have any limiting effect on the protection scope of the present invention.

The present invention relates to demonstration device enabling the contrast of mask filters, which may include a dust collecting partition plate which is installed on a rotatable dust collecting frame. On both sides of the dust collecting partition plate, a mask filter and a mask used as contrast device are installed. With measures the amount of dust on two dust collecting contrast blocks which are installed on the bottom of dust collecting frame, the dust-proof function of mask filter could be directly represented, ensuring good teaching quality.

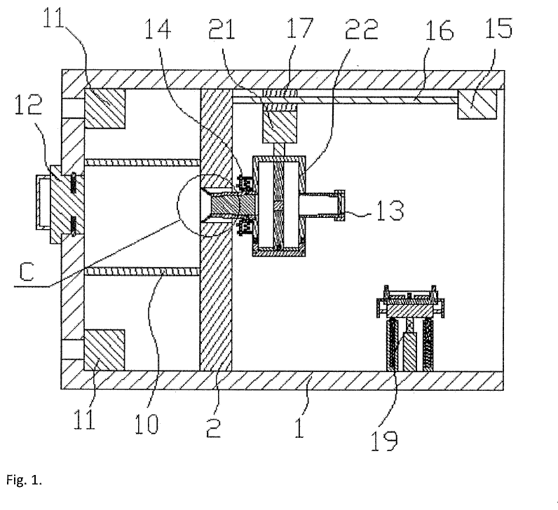

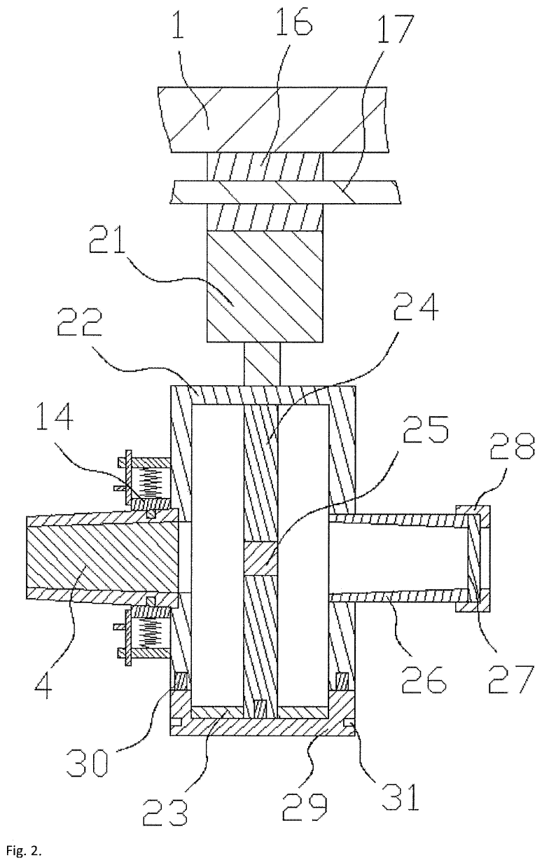

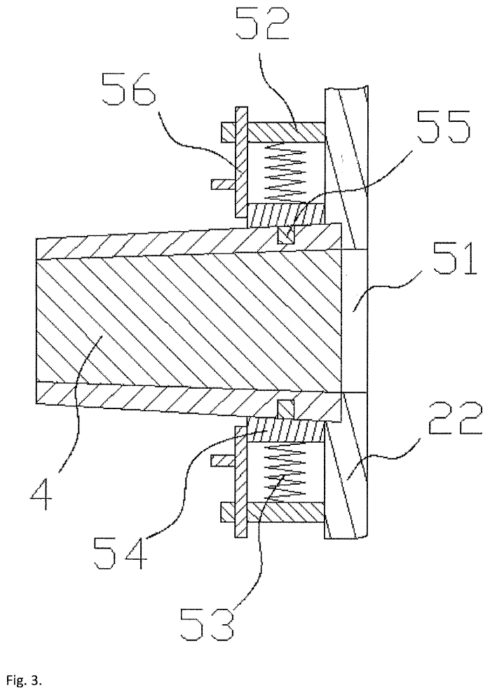

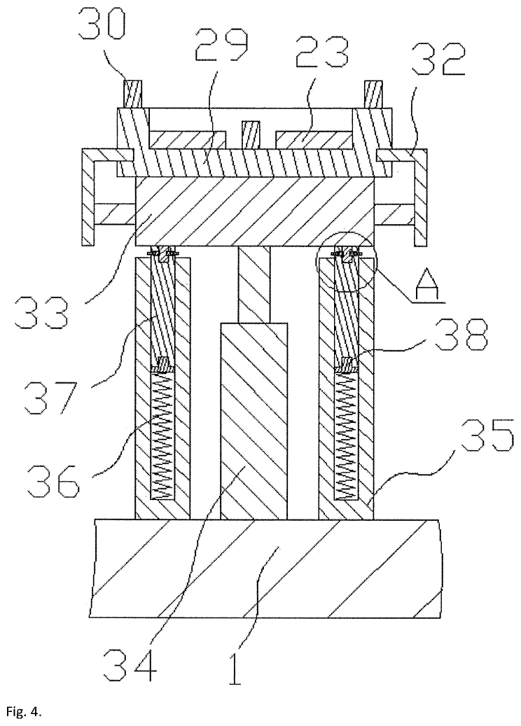

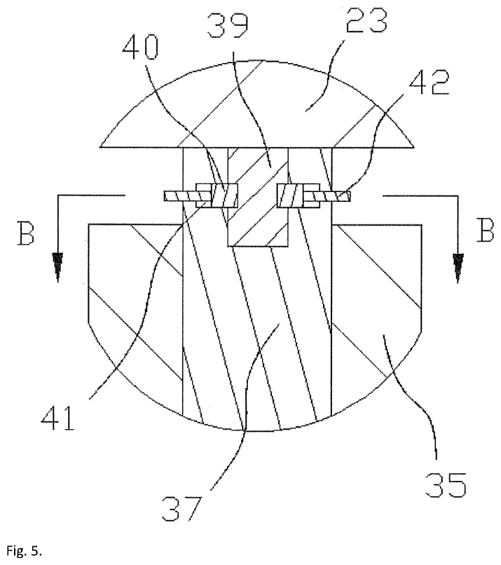

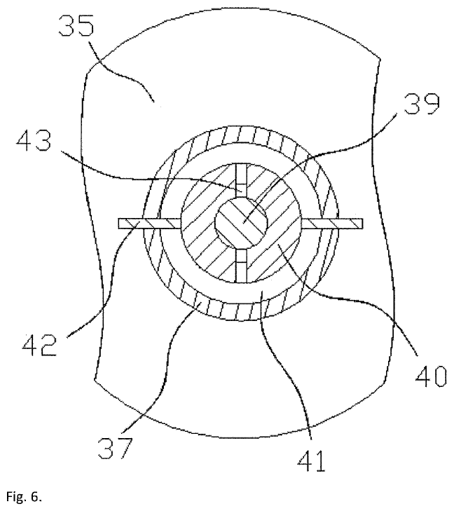

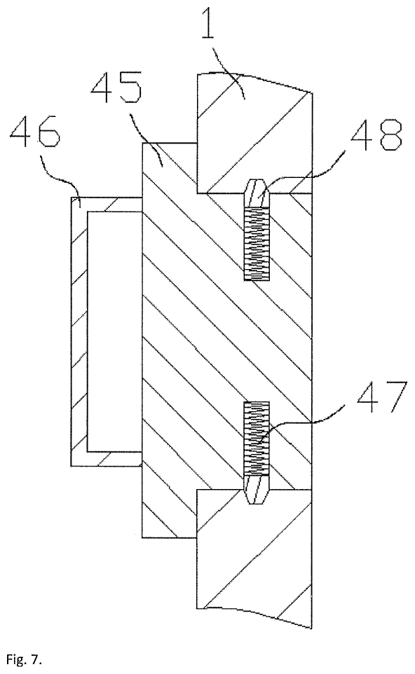

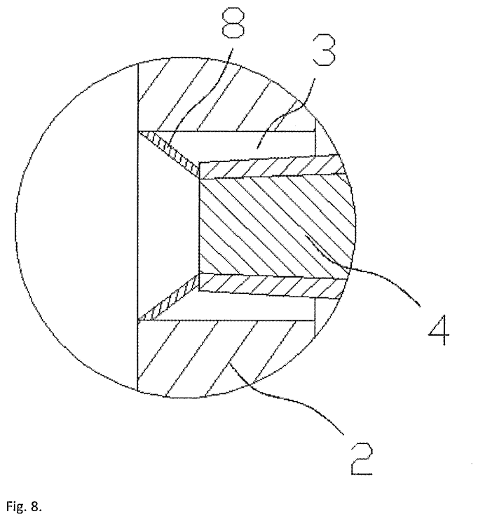

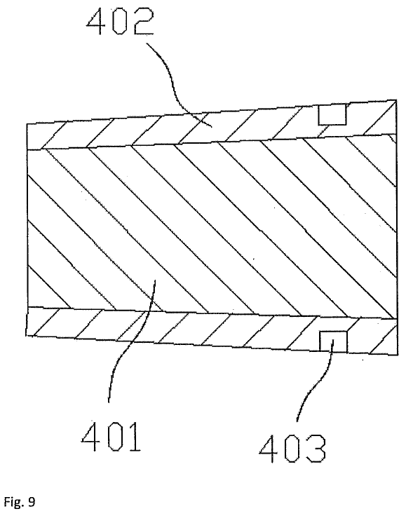

As it shown in FIGS. 1-9, the present invention demonstration device enabling the contrast of mask filters includes a cabinet 1 where a dust cavity and a demonstration cavity with right opening are formed with a partition plate 2. On the partition plate 2 is set a communication port to communicate the dust cavity with the demonstration cavity. On the upper part of the demonstration cavity, are set a dust collecting movable motor 15 and a dust collecting movable screw 16 which cooperate with each other, and on the said dust collecting movable screw 16, a dust collecting movable block 17 is fixed by plug push cooperation. To the lower end of the dust collecting movable block 17, a dust collecting rotary motor 21 is installed and under the dust collecting rotary motor 21, a dust collecting frame 22 is installed. In the middle of the dust collecting frame 22, a dust collecting partition plate 24 is installed. On the bottom of the dust collecting frame 22 and on both sides of the dust collecting partition plates 24, dust collecting contrast blocks 23 are installed. On either right and left sides of the dust collecting frame 22, a mask filter 4 and contrast device 13 which use masks to function which are both connected to the inner cavities are respectively installed. Both the mask filters 4 and contrast devices 13 are connected to the communication port 3.

Preferably, the left end of the communication port 3 is secured to a mask sealing conic sleeve 8 which is big in its left end and small in its right one. The right opening's size of the mask sealing conic sleeve 8 is bigger than the outer diameter of filter column 401 but smaller than the outer diameter of the left end of the filter sleeve 402.

Preferably, a dust blocking ventilation piece 10 is installed on both above and below the communication port and blowing air compressor 11 which blows air towards central part of the dust cavity are installed on the upper corner and lower corner of the dust cavity. And on side wall of the dust cavity between two dust blocking ventilation pieces 10, a material inlet cover 12 which may comprise a material inlet cover body 45 is installed. The material inlet cover body 45 fits the side walls of the dust cavity with plug push cooperation, and a material inlet handle 46 is installed thereon. On both upper and lower sides of the material inlet cover body 45, a cover position limit hole which runs vertically is fixed. The cover position limit holes are connected to cover position limit blocks 48 respectively via the cover position limit springs 47. On the side walls of the dust cavity, the cover position limit slots which cooperate the cover position limit blocks 48 are installed.

Preferably, on the left board of the dust collecting frame 22, a filter communication hole 51 which fits with the filter column 401 is installed. On the lower and upper end of the filter communication hole 51, a filter clamping device 14 which may comprise a filter holding and mounting block 52 which is secured to outer side board of the dust collecting frame 22 is installed. The side of the filter holding and mounting blocks 52 facing to the filter communication hole 51 are connected to a filter clamping block 54 which cooperates with the filter sleeve 402 by the clamping spring of filter 53. The outer side of the filter clamping blocks 54 is secured with a filter holding control rod 56 with handle and the filter holding control rod 56 is connected to the filter holding and mounting block 52 by plug fitting.

Preferably, the outer shape of the filter communication hole 51 is a tapered hole which fits the filter sleeve 402, while the inner one of filter communication hole 51 is a cylindrical hole which fits the right end of filter column 401. On outside of the filter sleeve 402, a clamping engaging hole is installed. In the same time, in the filter clamping block 54, a filter clamping pole 55 which fits clamping engaging hole 403 is installed.

Preferably, the contrast device may comprise a contrast sleeve 26 inserted to the right board of the dusting collection frame 22 and axis of which is consistent with that of filter column 401. Opening size of the contrast sleeve 26 is the same as that of the left side of the filter column 401. On the right side of the contrast sleeve 26, a mask 27 is installed by a mask locking sleeve 28 and in the middle of the mask locking sleeve 28, a ventilation port is installed, whose opening is coincident with the that of the contrast sleeve 26.

Preferably, the dust collecting frame 22 is frame with open lower end, where a lower dust collecting case 29 is connected therein. On the lower dusting collecting case 29, lower case plug rods 30 which fits the dust collecting frames 22 and the dust collecting partition plate 24 are installed by plug and fit connection. The dust collecting contrast block 23 are installed in the lower dusting collecting case 29. And on the left and right to the outside of the dust collecting frame 22, lower case reclaiming openings 31 are set. To the right side of the lower end of the demonstration cavity, a lower dusting collecting case holding device 19 which fits the lower case reclaiming opening 31 is installed.

Preferably, the lower dusting collecting case holding device 19 may comprise a lower case claiming and lifting gas cylinder 34 which is installed on the bottom board of the cabinet 1. On the lower case claiming and lifting gas cylinder 34, a lower case clamping gas cylinder 33 which runs horizontally is installed. And the left and right ends of the lower case clamping gas cylinder 33 is connected to a lower case clamping block 32 which fits the lower case reclaiming opening 31. While the lower case clamping block 32 fits the lower case reclaiming opening 31 by plug push cooperation, the bottom of the lower dusting collecting case 29 contacts the upper side of the lower case clamping gas cylinder 33.

Preferably, under the lower case clamping gas cylinder 33 on the cabinet 1 are fixed clamping buffers 35. In the clamping buffer 35, there is installed a clamping buffer hole and a clamping buffer spring 36 is installed in the hole. The clamping buffer spring 36 is connected to clamping buffer column 37, and the upper end of the clamping buffer column 37 is connected to the lower case clamping gas cylinder 33.

Preferably, on the upper end of the clamping buffer spring 36, a spring connection block 38 is installed. The spring connection block 38 is in inverted T shape, whose vertical portion is a threaded rod. The lower end of the clamping buffer column 37 fits the spring connection block 38 by thread connection. On the lower part of the lower case clamping gas cylinder 33, a buffer column socket 39 which matches the upper end of the clamping buffer column 37 with plug push cooperation is installed. In the middle of the buffer column socket 39 is set an annular groove of damping column 43, the counterpart of which in the clamping buffer column 37 is set a movable annular groove of clamping arc block 41. In the movable annular groove of clamping arc block 41, is set a buffer column positioning arc block 40 which cooperates with the buffer column positioning ring slot 43, and is connected to a movable positioning arc block fixing pole 42.

In a preferred use, the user may assemble the invention first and install the mask filter 4 and the mask 27. Then the user may open the material inlet cover 12 and put dust into the dust cavity. After closing the material inlet cover 12, make the cover position limit blocks 48 to plug into the block slot of cover body. The dust collecting movable motor drives the dust collecting frame 22 to the left and make mask filter 4 presses against the mask sealing conic sleeve 8 to finish the sealing process of mask filter 4. With the upper and lower blowing air compressors 11 blowing the dust together to simulate the fluid environment of factories and then the user activate the respiratory pump in 5 minutes. After stopping the respiratory pump, the dust may fall on the corresponding dust collecting contrast blocks 23 through the mask filter 4. The dust collecting movable motor 15 may drive the dust collecting frame 22 to rotate in 180 degrees and the dust collecting movable motor 15 may drive the dust collecting frame 22 to the left until mask locking sleeve 28 may press against the mask sealing conic sleeve 8. With stopping respiratory pump in 5 minutes, the dust will fall on corresponding dust collecting contrast blocks 23. Then dust collecting movable motor 15 may drive dust collecting frame 22 to the right above the lower dusting collecting case holding device 19 and the lower case claiming and lifting gas cylinder 34 may drive the lower case clamping gas cylinder 33 to the lower dusting collecting case 29. Then the lower case clamping gas cylinder 33 may drive lower case clamping block 32 and make it inserted into the lower case reclaiming opening 31. The lower dusting collecting case may be pulled out as lower case claiming and lifting gas cylinder 34 are retracted downward. In the above process, clamping buffer spring may conduce to damping function and the user may pick out the dust collecting contrast block 23 in the lower dusting collecting case 29. The user may put a new dust collecting contrast block 23 and make lower dusting collecting case 29 inserted below the dust collecting frame 22. To put the lower dusting collecting case holding device 19 to the original position, at the same time, the user may replace the mask 27 with a new one and may compare the two dust collecting contrast blocks 23 from the lower dusting collecting case 29. The user may find that the dust on the dust collecting contrast block 23 corresponding to the mask 27 is much more than the dust on the dust collecting contrast block 23 corresponding to the mask filter. Therefore, a great teaching experience may be achieved by knowing that the mask filter is much more dust-proof than the mask.

After a mask filter are used for a certain period, it may be removed to the right opening of cabinet 1. The user may use filter holding control rod 56 to open clamping block of filter 54 and then the user may replace the mask filter with a new one with filter holding control rod 56 to finish clamping process of the mask filter.

It should be noted that, in the present document, the term “comprising”, “including”, or any other variation thereof, is intended to cover a non-exclusive inclusion, such that a process that includes a series of elements, a method, an article or a device not only comprise those elements, but also comprise other elements which are not explicitly listed, a method, an article, or a device.

The principles and implementation mode of the present invention are described by applying a specific example in the present document, and the description of the above examples is only used to help understand the method of the present invention and the core idea thereof.

The foregoing is only a preferred embodiment of the present invention, and it should be noted that the present invention is not limited to the above-mentioned preferred embodiments, and the present invention is not limited to the above-mentioned preferred embodiments, and because of the finite character expression, an infinite specific structure exists objectively, and for a person of ordinary skill in the art, several improvements can also be made without departing from the principle of the present invention, and the technical features can also be combined in an appropriate manner; and these improvements are modified, changed or combined, or the concept and the technical solution of the present invention are directly applied to other occasions without improvement The present invention is characterized in that the first-level display screen is provided with a first-level display screen and a second-level display screen, and the first-level display screen and the second-, should be considered as a protection scope of the present invention.

What is claimed is:

1. A demonstration device enabling the contrast of mask filters comprising a cabinet (1) wherein a dust cavity and a demonstration cavity with right opening are formed with a partition plate (2). On the partition plate (2) is set a communication port to communicate the dust cavity with the demonstration cavity. On the upper part of the demonstration cavity, are set a dust collecting movable motor (15) and a dust collecting movable screw (16) which cooperate with each other, and on the said dust collecting movable screw (16), a dust collecting movable block (17) is fixed by plug push cooperation. To the lower end of the dust collecting movable block (17), a dust collecting rotary motor (21) is installed and under the dust collecting rotary motor (21), a dust collecting frame (22) is installed. In the middle of the dust collecting frame (22), a dust collecting partition plate (24) is installed. On the bottom of the dust collecting frame (22) and on both sides of the dust collecting partition plates (24), dust collecting contrast blocks (23) are installed. On either right and left sides of the dust collecting frame (22), a mask filter (4) and contrast device (13) which use masks to function which are both connected to the inner cavities are respectively installed. Both the mask filters (4) and contrast devices (13) are connected to the communication port (3).

2. The demonstration device enabling the contrast of mask filters of claim 1, wherein the left end of the communication port (3) is secured to a mask sealing conic sleeve (8) which is big in its left end and small in its right one. The right opening's size of the mask sealing conic sleeve (8) is bigger than the outer diameter of filter column (401) but smaller than the outer diameter of the left end of the filter sleeve (402).

3. The demonstration device enabling the contrast of mask filters of claim 1, wherein a dust blocking ventilation piece (10) is installed on both above and below the communication port and blowing air compressor (11) which blows air towards central part of the dust cavity are installed on the upper corner and lower corner of the dust cavity. And on side wall of the dust cavity between two dust blocking ventilation pieces (10), a material inlet cover (12) which may comprise a material inlet cover body (45) is installed. The material inlet cover body (45) fits the side walls of the dust cavity with plug push cooperation, and a material inlet handle (46) is installed thereon. On both upper and lower sides of the material inlet cover body (45), a cover position limit hole which runs vertically is fixed. The cover position limit holes are connected to cover position limit blocks (48) respectively via the cover position limit springs (47). On the side walls of the dust cavity, the cover position limit slots which cooperate the cover position limit blocks (48) are installed.

4. The demonstration device enabling the contrast of mask filters of claim 1, wherein on the left board of the dust collecting frame (22), a filter communication hole (51) which fits with the filter column (401) is installed. On the lower and upper end of the filter communication hole (51), a filter clamping device (14) which may comprise a filter holding and mounting block (52) which is secured to outer side board of the dust collecting frame (22) is installed. The side of the filter holding and mounting blocks (52) facing to the filter communication hole (51) are connected to a filter clamping block (54) which cooperates with the filter sleeve (402) by the clamping spring of filter (53). The outer side of the filter clamping blocks (54) is secured with a filter holding control rod (56) with handle and the filter holding control rod (56) is connected to the filter holding and mounting block (52) by plug fitting.

5. The demonstration device enabling the contrast of mask filters of claim 4, wherein the outer shape of the filter communication hole (51) is a tapered hole which fits the filter sleeve (402), while the inner one of filter communication hole (51) is a cylindrical hole which fits the right end of filter column (401). On outside of the filter sleeve (402), a clamping engaging hole is installed. In the same time, in the filter clamping block (54), a filter clamping pole (55) which fits clamping engaging hole (403) is installed.

6. The demonstration device enabling the contrast of mask filters of claim 2, wherein the contrast device may comprise a contrast sleeve (26) inserted to the right board of the dusting collection frame (22) and axis of which is consistent with that of filter column (401). Opening size of the contrast sleeve (26) is the same as that of the left side of the filter column (401). On the right side of the contrast sleeve (26), a mask (27) is installed by a mask locking sleeve (28) and in the middle of the mask locking sleeve 28, a ventilation port is installed, whose opening is coincident with the that of the contrast sleeve (26).

7. The demonstration device enabling the contrast of mask filters of claim 1, wherein the dust collecting frame (22) is frame with open lower end, where a lower dust collecting case (29) is connected therein. On the lower dusting collecting case (29), lower case plug rods (30) which fits the dust collecting frames (22) and the dust collecting partition plate (24) are installed by plug and fit connection. The dust collecting contrast block (23) are installed in the lower dusting collecting case (29). And on the left and right to the outside of the dust collecting frame (22), lower case reclaiming openings (31) are set. To the right side of the lower end of the demonstration cavity, a lower dusting collecting case holding device (19) which fits the lower case reclaiming opening (31) is installed.

8. The demonstration device enabling the contrast of mask filters of claim 7, wherein the lower dusting collecting case holding device (19) may comprise a lower case claiming and lifting gas cylinder (34) which is installed on the bottom board of the cabinet (1). On the lower case claiming and lifting gas cylinder (34), a lower case clamping gas cylinder (33) which runs horizontally is installed. And the left and right ends of the lower case clamping gas cylinder (33) is connected to a lower case clamping block (32) which fits the lower case reclaiming opening (31). And when the lower case clamping block (32) fits the lower case reclaiming opening (31) by plug push cooperation, the bottom of the lower dusting collecting case (29) contacts the upper side of the lower case clamping gas cylinder (33).

9. The demonstration device enabling the contrast of mask filters of claim 8, wherein under the lower case clamping gas cylinder (33) on the cabinet (1) are fixed clamping buffers (35). In the clamping buffer (35), there is installed a clamping buffer hole and a clamping buffer spring (36) is installed in the hole. The clamping buffer spring 36 is connected to clamping buffer column (37), and the upper end of the clamping buffer column (37) is connected to the lower case clamping gas cylinder (33).

10. The demonstration device enabling the contrast of mask filters of claim 9, wherein on the upper end of the clamping buffer spring (36), a spring connection block (38) is installed. The spring connection block (38) is in inverted T shape, whose vertical portion is a threaded rod. The lower end of the clamping buffer column (37) fits the spring connection block (38) by thread connection. On the lower part of the lower case clamping gas cylinder (33), a buffer column socket (39) which matches the upper end of the clamping buffer column (37) with plug push cooperation is installed. In the middle of the buffer column socket (39) is set an annular groove of damping column (43), the counterpart of which in the clamping buffer column (37) is set a movable annular groove of clamping arc block (41). In the movable annular groove of clamping arc block (41), is set a buffer column positioning arc block (40) which cooperates with the buffer column positioning ring slot (43), and is connected to a movable positioning arc block fixing pole (42).
